(19) United States
(12) Patent Application Publication
(10) Pub. No.: US 2004/0198441 A1
(43) Pub. Date: Oct. 7, 2004

(54) Wireless communication device and method

(76) Inventors: George Cooper, Novato, CA (US); Robert Cooper, La Quinta, CA (US)

Correspondence Address: Todd A. Noah, Dergosits & Noah LLP, Suite 1450, Four Embarcadero Center, San Francisco, CA, 94111, US

(21) Appl. No.: 10/272,841

(22) Filed: Oct. 16, 2002

Related U.S. Application Data
(60) Provisional application No. 60/399,503, filed on Jul. 29, 2002.

(51) Int. Cl. H04B 1/38; H04Q 7/20

(52) U.S. Cl. 455/557; 455/457; 455/521; 455/456.1; 455/404.1; 455/414.1

(57) ABSTRACT

The present invention is directed to an apparatus, system and method for providing a user-initiated, non-voice communication. The apparatus includes an antenna for communicating within a control channel of a telephone communication network, and a communication device connected to the cellular antenna. The communication device includes (1) a memory storage device for storing information, (2) a preprogrammed circuit having at least one stock message that incorporates some or all of the stored information, and (3) a user interface connected to the preprogrammed circuit.

### CROSS-REFERENCE TO RELATED APPLICATION

This application claims priority to provisional patent application serial No. 60/399,503 filed on Jul. 29, 2002, which is incorporated herein by reference in its entirety.

### FIELD OF INVENTION

The present invention relates to a mobile apparatus, system and method for economically sending a user-initiated, non-voice communication to a central location. In particular, the present invention relates to an apparatus, system and method for sending a user-initiated, non-voice communication via the control band of a telephone communication network.

### BACKGROUND OF THE INVENTION

A variety of services are currently available to a remote user, who is in need of assistance. These services are typically centered around wireless voice communications, wherein the user communicates a request for assistance by contacting a central operator. The operator than takes the necessary steps to respond to the request for assistance. These services can be costly because of the need for both wireless voice communication services and a human interface to accurately ascertain the request for assistance.

Accordingly, there is a need for economically and accurately communicating a request for assistance, e.g., emergency services, without the need for an expensive cellular phone service.

### SUMMARY OF THE INVENTION

The present invention provides a solution to the need for economically and accurately communicating a request for assistance.

The present invention is directed to a mobile apparatus for providing a user-initiated, non-voice communication. The apparatus includes an antenna for communicating within a control channel of a telephone communication network, and a communication device connected to the cellular antenna. The communication device includes (1) a memory storage device for storing information, (2) a preprogrammed circuit having at least one stock message that incorporates some or all of the stored information, and (3) a user interface connected to the preprogrammed circuit. The user interface can include an actuator that triggers the sending of a particular stock message by the communication device to a central location. The user interface is preferably wirelessly connected to the communication device.

The stock message can be selected from the group consisting of a request for medical assistance, a request for roadside assistance, a request for police assistance, a request for insurance adjuster assistance, a request for fire department assistance, and combinations thereof.

In one embodiment, the mobile apparatus further includes a position locating system that provides location data to the memory storage device. The position locating system can include a global positioning system (GPS) receiver antenna, and a GPS circuit connected to the GPS receiver antenna.

The present invention is also directed to a user initiated, non-voice communication system for requesting assistance. The system includes (A) a mobile apparatus for sending a user-initiated, non-voice message having a service request, user identification information, and location information, (B) a telephone communication network having a control band, (C) a service provider for receiving the non-voice message, and (D) a message processing system.

The present invention is also directed to a method for sending a user-initiated, non-voice communication. The method includes sending a user-initiated, non-voice message for a service request via the control band of a telephone communication network, and processing the received message.

### BRIEF DESCRIPTION OF THE DRAWINGS

While the specification concludes with claims particularly pointing out and distinctly claiming the subject matter, which is regarded as defining the present invention, it is believed that the invention will be better understood from the following description taken in conjunction with the following accompanying drawings:

FIG. 1a is a side view of one embodiment of a mobile apparatus according to the present invention;

FIG. 1b is a top view of one embodiment of a mobile apparatus according to the present invention;

FIG. 2 is an illustration of one embodiment of a wireless user interface according to the present invention; and

FIG. 3 is an illustration of the signal flow for one embodiment of the present invention.

### DETAILED DESCRIPTION OF THE INVENTION

The present invention provides a mobile apparatus, system and method for economically sending a user-initiated, non-voice communication to a central location, which processes the message. Since the communication sent by the mobile apparatus can be processed automatically, a remote user may effectively communicate a service request with minimal assistance. The non-voice communication can be a stock message, which means a pre-programmed message containing a request and stored information. For example, a stock message can be understood, and an associated action taken, without utilizing an operator to ascertain the needs of the remote user. Furthermore, since such stock messages do not require the use of voice communications that require large bandwidth, the message can be economically sent using the control channel of a telephone communication network.

Telephone communication networks typically have a voice channel and a control channel, as disclosed in U.S. Pat. Nos. 5,845,203 and 5,54,740, which are both incorporated herein by reference in their entirety. Examples of such telephone networks include, but are not limited to, American Mobile Phone system (AMPS), Total Access Communications System (TACS), personal communication systems (PCS), Global system for Mobile (GSM) networks, and satellite telephone networks. The term “telephone communication network” and “communication network,” as used herein, mean any system of wireless communication that is capable of sending and receiving streams of data.

The mobile apparatus of the present invention includes (i) an antenna for communicating in a control channel of a telephone communication network and (ii) a communication device connected to the cellular antenna. The antenna may be any suitable antenna that is typically used in cellular mobile radio networks.

The communication device includes (a) a memory storage device for storing information for transmission; (b) a preprogrammed circuit having at least one stock message to be transmitted; and (c) a user interface connected to the preprogrammed circuit.

The memory storage device can be any data storage device known to the skilled artisan. Preferably, the data storage device has the capability to read over old data in order to minimize its size. Examples of suitable memory storage devices include, but are not limited to, semiconductor memory chips (e.g., DRAM, SRAM, and flash memory).

The memory storage device can be configured to store all or any combination of the following information: location data, vehicle operation data, user identification data, vehicle identification data, insurance data, vehicle owner data, embedded device identification, service request, and the like. Vehicle identification data and insurance data can be alternatively stored in a customer profile, as described hereinafter, at a central location. Nonlimiting examples of location data include longitude and latitude. Nonlimiting examples of vehicle operation data include a sequence of longitude and latitude data sufficient to calculate speed and direction of vehicle prior to service request. Nonlimiting examples of user identification data include the serial number of the device embedded in the vehicle. Nonlimiting examples of vehicle identification data include the license number, the VIN number, and the vehicle make. Nonlimiting examples of insurance data include policy number and name of insurance company.

The information that is constant, such as user identification data and vehicle identification data, may be preprogrammed into the communication device during installation. However, the information that is periodically updated, such as location data and vehicle operation data, can be provided by supplementary devices. The stored information can also include a predetermined amount of historical data, e.g., the last 20 entries, which can be periodically updated.

Location data, for example, can be provided by any position locating device/system that is known to the skilled artisan or commercially available and located in the device that is embedded in the vehicle. Such position locating systems typically include a global positioning system (GPS) receiver antenna and a GPS circuit, which can be connected to the memory device. The position locating device/system can be incorporated into the communication device and connected to the memory storage device. Alternatively, the location data can be provided via a data link to the memory storage device from a position locating device/system that is already present in a vehicle. Useful position locating systems are disclosed in U.S. Pat. Nos. 5,959,577 and 5,990,827, which are incorporated herein by reference in their entirety. In order to provide accurate location information, the location data is updated periodically, preferably within every minute, more preferably within every second, and most preferably within every tenth (1/10) of a second.

Similarly, vehicle operation data can be provided by way of a data link with a vehicle computer. Vehicle operation data can include, but is not limited to, vehicle velocity, heading data, and combinations thereof. These data can be calculated from longitude and latitude data knowing the time interval between readings. In order to provide accurate vehicle operation information, the vehicle operation data is updated periodically, preferably within every minute, more preferably within every second, and most preferably within every tenth (1/10) of a second.

The preprogrammed circuit includes circuitry to send a selected stock non-voice message through the control channel of a telephone network. The circuitry is configured to be compatible with one or more telephone service providers. The circuitry for processing and transmitting the message through the control channel is disclosed in U.S. Pat. Nos. 5,594,740 and 5,845,203, which are incorporated herein by reference in their entirety. Once activated by the user, the preprogrammed circuit sends the selected stock message containing the relevant stored information or all of the stored information. For example, the preprogrammed circuit can include a logic device, which has preprogrammed stock messages. The logic device can be connected to the memory storage device and the circuitry for processing and transmitting the message through the control channel. Once a signal is received from the user interface, the logic device can send the selected message corresponding to the signal and include the relevant stored information.

The stock messages can include, but are not limited to, a request for medical assistance, a request for roadside assistance, a request for police assistance, a request for insurance adjuster assistance, a request for fire department assistance, and combinations thereof. Each of these stock messages requires the inclusion of at least the stored location data and user identification data. The stock message can also include a combined request. For example, a message pertaining to an accident without injuries can include a combined request for both police assistance and insurance adjuster. Similarly, a message pertaining to an accident with injuries can include a combined request for police assistance, insurance adjuster assistance, and medical assistance.

The user interface is connected to the preprogrammed circuit so that the user can select and send a stock message from the preprogrammed circuit. The user interface includes an actuator that, upon selection by the user, triggers the sending of a selected stock message. The user interface can be in any form known to the skilled artisan that allows selection of the stock messages and activation of the actuator to send the selected message. For example, the user interface can be a panel having a plurality of buttons, wherein each button corresponds to a particular stock message. In this example, the buttons are the actuator. The panel can alternatively have a display providing a menu of the stock messages. Selection of a stock message can active a central actuator that instructs the preprogrammed circuit to send the selected message.

The user interface is preferably wirelessly connected to the preprogrammed circuit. The wireless user interface further includes a signal initiator in a detachable user interface and a signal receiver located in the communication device, e.g., on the preprogrammed circuit. For example, the signal receiver can be connected to the circuitry to send a selected stock non-voice message, as described above. The technology for such wireless connections is well known in the art. For example, most commercial automobiles are typically sold with a key fob (also known as a remote control for keyless entry) that allows remote wireless operation of various functions, such as locking/unlocking doors, opening the trunk, and activating the alarm. The same circuitry for these automobile key fobs can also be utilized in the wireless user interface of the present invention. In one embodiment, the signal receiver can be a plurality of switches, which are wireless activated by radio signals received from the signal initiator in the user interface. In this embodiment, each switch corresponds to a particular stock message. Upon activation of a particular switch, the preprogrammed circuit can send a corresponding message, as described above.

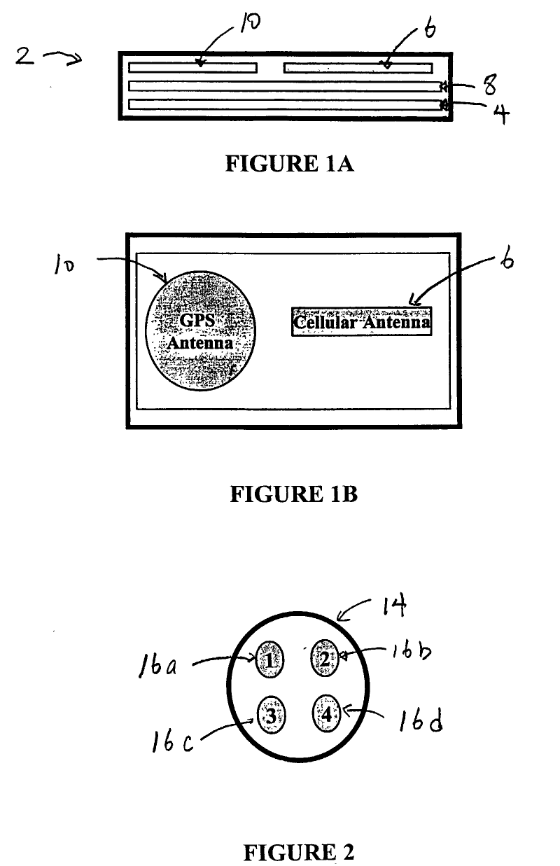

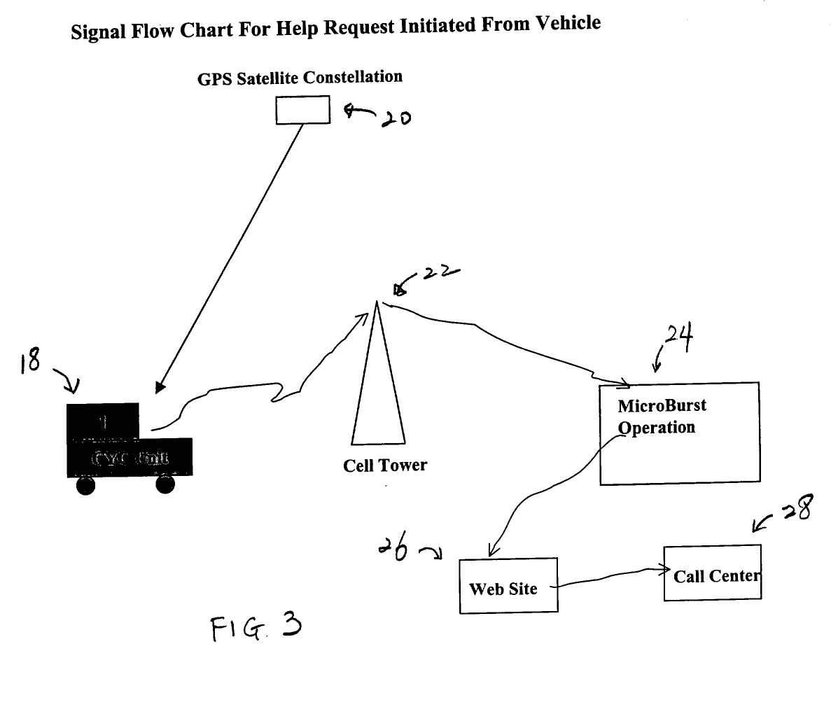

One embodiment of the mobile apparatus is illustrated in FIGS. 1A, 1B, and 2. In this embodiment, the mobile apparatus 2 includes an AMPS Microburst radio board 4 (commercially available as model DM 10 from Ericcson, located in Stockholm, Sweden), which is connected to a cellular stub antenna 6. The AMPS Microburst radio board is also commercially available as model CMM 8600 or CMM 8700 from Skybility (formally Standard Communications) located in Carlsbad Calif. Similar AMPS Microburst radio boards are also commercially available from Axiom Navigation located in Anaheim, Calif. The Microburst radio board 4 includes (i) a signal receiver, not shown, for receiving a wireless signal from a detachable user interface, (ii) a preprogrammed circuit, not shown, containing the stock messages, and (iii) a memory storage device, not shown, for storing all of the information. The Microburst radio board 4 sends the selected stock message with all relevant stored information to a central location via the cellular stub antenna 6. The standard microburst radio units can be modified by adding switches that can be activated upon the receipt of the wireless signal corresponding to a particular service request selected by the user on the detachable user interface. Once activated, a particular switch can direct the preprogrammed circuit to send the selected message along with the relevant stored data. These switches are standard devices in common usage by cellular telephone equipment suppliers, such as Ericcson.

In this embodiment, the mobile apparatus 2 also includes a GPS SiRF Star-II chipset board 8 (commercially available from Axiom Navigation, located in Anaheim, Calif.), which is connected to a GPS receiver antenna 10 (also commercially available from Axiom Navigation). Raw location data is received from any position locating device/system known in the art, such as a global positioning system utilizing a network of satellites. The raw location data is received via the GPS receiver antenna 10 and processed by the GPS SiRF Star-II chipset board 8 to produce usable location data, e.g., longitude and latitude. Once processed by the board 8, the location data is stored in the memory module, not illustrated, located on the AMPS Microburst radio board 4.

All of these components can be encased in an enclosure made of a suitable material, such as electronics grade plastic. Due to the small size of the components, the mobile apparatus can be about the size of a deck of playing cards, and can be connected to an appropriate electrical source, such a battery pack or the vehicle electrical system, via a short cable with a standard connector.

As illustrated by FIG. 2, this embodiment also includes a wireless user interface 14 (e.g., a wireless key fob) including a signal initiator, not shown, and a plurality of function keys or buttons 16a-16d. The signal initiator is a standard device commonly used in many industries including telephone fabrication and automobile keyless entry systems.

Although the illustration in FIG. 2 only provides four service request keys/buttons, the number of keys/buttons can be varied according preferences. Each service request key/button 16a-16d, when pushed, acts as an actuator for sending a stock message corresponding to a particular key/button via the signal initiator to the signal receiver located on the Microburst radio board 4. For example, each of the keys/buttons can correspond to a message for a request for assistance according to the following situations: (a) medical incapacitation (e.g., a request for medical assistance); (b) automobile disablement (e.g., a request for roadside assistance); (c) an accident without injuries (e.g., a request for police assistance and insurance adjuster assistance; and (d) an accident with personal injuries (e.g., a request for police assistance, medical assistance, insurance adjuster assistance, and a request for fire department assistance). These messages can be customized. The button can be required to be held down for at least three seconds to avoid the possibility of accidental signals being transmitted. In addition, an audible tone can be emitted by the communication device when the signal has been sent.

The present invention is also directed to a system for economically sending a user-initiated, non-voice communication via a communication network to a central location, which processes the remote user's request. The system includes (i) a mobile apparatus for sending a user-initiated, non-voice message, (ii) a telephone communication network having a control band, (iii) a telephone service provider for receiving the non-voice message, and (iv) a message processing system. Both the mobile apparatus and telephone communication network have been described above.

The telephone service provider has the capability to receive the non-voice message from a remote user via the control band of a telephone communication network. Accordingly, the preprogrammed circuit in the mobile communication device is configured to match the requirements of at least one telephone service providers. One useful service provider is Aeris.net located in San Jose, Calif. For example, the configuration requirements for transmitting data over the control channels of a telephone communication network is described in U.S. Pat. Nos. 5,594,740 and 5,845,203. In addition, the service provider can periodically, e.g., every month, contact each unit to provide a quality check on system operation. A list of non-responsive mobile communication units can be provided for follow up. Upon receiving the non-voice message, the communication service provider automatically sends the message to the message processing system.

The message processing system processes the message to initiate the requested action. Receipt of the message by the communication service provider and processing of the message can be conducted by one or more entities. In addition, each step of processing the received message can be conducted by one or more additional entities. The message processing system includes (i) a user identification system for matching the received message with a user profile, and (ii) a service activation system for initiating the requested service in the received message. Each of these systems can include one or more computers.

Since the stock message contains at least a service request, location information, and user identification information, the user identification system matches the stock message with a user profile stored on a central database containing all of the user profiles. The user profile can include the following information: vehicle owner information, vehicle identification data include the VIN number, license number, vehicle make, insurance data include policy number and name of insurance company, and combinations thereof.

Once the user profile is matched with the received message, the service activation system initiates the requested action in the message. The service activation system (i) stores the user profile and message in a secure but accessible form and (ii) contacts the appropriate service centers (e.g. medical, police, roadside assistance, insurance, and fire department) according to the request in the message.

For example, the relevant information can be stored on a secure web page that is accessible by the service centers. The web page can be configured to display the user request and the location data (e.g., latitude and longitude) in a user-friendly format, such as a map, for locating the remote user. In one embodiment, the location information can be converted to a street map, which is accessible by a secure Internet web page, as described in U.S. Pat. Nos. 5,959,577 and 5,990,827, which are incorporated herein by reference. The street map can include the street address and the service request.

In addition, the secure web page can have a plurality of elements, wherein one secure element is available for each client. Furthermore, each element can have a plurality of secure sub-elements of the total data, such as stolen vehicles, accident reports, roadside disablement's, etc. The web page content can be automatically available to the service center from the web page. Data can be continually downloaded (like an e-mail transmission) or can be viewed directly on the web page.

The web page can also be configured to automatically contact the appropriate service centers according to the received message. Access to the web page can be available to all of the notified service centers. For example, an insurance claims center desk is notified for a request for accident assistance; a tow truck service center desk is notified for a mechanical disablement request; and a medical assistance service desk is notified for a medical assistance request. The data on the secure web page can be sorted by event and passed automatically to the location selected for response to the request.

The present invention is also directed to a method of economically sending a user-initiated, non-voice communication from a remote location to a central location having a message processing system, which can automatically process a remote user's request. The method includes (a) sending a user-initiated, non-voice message for a service request via the control band of a telephone communication network, and (b) processing the received message. The message can include a service request and relevant stored information, such as user identification information and location information. The message can be processed by (i) matching the received message with a user profile, (ii) storing the user profile and message in a secure but accessible form, and (iii) contacting the appropriate service centers according to the request in the message.

One embodiment of the system and method is illustrated in FIG. 3. Location information is received from a GPS satellite 20 and stored in a mobile apparatus located in a vehicle 18. When the user selects a particular message on a wireless user interface, not shown, the communication device, not shown, installed in the vehicle 18 transmits the selected message containing a service request to a telephone service provider 23 via a cellular network 22. As described above, the message contains at least a service request, user identification information, and location information. An audible tone can be emitted from the communication device when the Microburst signal has been sent. The service provider 24 can relay the telephone message to a secure web site 26. Since the vehicle is not moving, a single set of coordinates can be posted and a single map location can be identified. The data is sorted by service requested and automatically provided to the appropriate service desk 28. When assistance has been dispatched, a signal can be sent to the mobile apparatus, which can emit a second distinct tone to alert the client that help is on the way.

What is claimed is:

1. A mobile apparatus for providing a user-initiated, non-voice communication, comprising:
(A) an antenna for communicating within a control channel of a telephone communication network;
(B) a communication device connected to the cellular antenna, the communication device comprising,
(1) a memory storage device for storing information;
(2) a preprogrammed circuit having at least one stock message that incorporates some or all of the stored information; and
(3) a user interface connected to the preprogrammed circuit, comprising an actuator that triggers the sending of a particular stock message by the communication device to a central location.

2. The mobile apparatus according to claim 1, wherein the user interface is wirelessly connected to the communication device.

3. The mobile apparatus according to claim 2, wherein the user interface further includes a signal initiator and the communication device further includes a signal receiver.

4. The mobile apparatus according to claim 1, wherein the stored information is selected from the group consisting of location data, vehicle operation data, user identification data, vehicle identification data, insurance data, and combinations thereof.

5. The mobile apparatus according to claim 4, wherein the location data is provided by a position locating system.

6. The mobile apparatus according to claim 6, wherein the position locating system comprises a global positioning system (GPS) receiver antenna, and a GPS circuit connected to the GPS receiver antenna.

7. The mobile apparatus according to claim 1, wherein the stock message is selected from the group consisting of a request for medical assistance, a request for roadside assistance, a request for police assistance, a request for insurance adjuster assistance, a request for fire department assistance and combinations thereof.

8. The mobile apparatus according to claim 7, wherein the stock message includes a request for police assistance and a request for insurance adjuster assistance.

9. The mobile apparatus according to claim 8, wherein the stock message further includes a request for medical assistance.

10. A user initiated, non-voice communication system, comprising:
(A) a mobile apparatus for sending a user-initiated, non-voice message comprising a service request, user identification information, and location information;
(B) a telephone communication network having a control band;
(C) a service provider for receiving the non-voice message; and
(D) a message processing system.

11. The system according to claim 10, wherein the mobile apparatus comprises
(A) an antenna for communicating within a control channel of a telephone communication network;
(B) a communication device connected to the cellular antenna, the communication device comprising,
(1) a memory storage device for storing information;
(2) a preprogrammed circuit having at least one stock message that incorporates some or all of the stored information; and
(3) a user interface connected to the preprogrammed circuit, comprising an actuator that triggers the sending of a particular stock message by the communication device to a central location.

12. The system according to claim 11, wherein the mobile apparatus further comprises a position locating system comprising a global positioning system (GPS) receiver antenna, and a GPS circuit connected to the GPS receiver antenna.

13. The system according to claim 10, wherein the message processing system comprises a user identification system for matching the received message with a user profile, and a service activation system for initiating the requested service in the received message.

14. The system according to claim 13, wherein the service activation system is capable of storing the user profile and the received message in a secure but accessible form and contacting one or more service centers according to the request in the message.

15. The system according to claim 14, wherein the user profile and received message is stored on a secure web page that is accessible by the service centers.

16. The system according to claim 15, wherein the received message includes location information.

17. The system according to claim 16, wherein the secure web page includes a graphical map providing the location of the user.

18. The system according to claim 14, wherein the service center is selected from the group consisting of a medical service center, a roadside assistance service center, a police service center, an insurance adjuster service center, a fire department service center and combinations thereof.

19. A method for sending a user-initiated, non-voice communication, the method comprising:
(A) sending a user-initiated, non-voice message for a service request via the control band of a telephone communication network; and
(B) processing the received message.

20. The method according to claim 19, wherein the message comprises a service request and relevant stored information.

21. The method according to claim 20, wherein the service request is selected from the group consisting of a request for medical assistance, a request for roadside assistance, a request for police assistance, a request for insurance adjuster assistance, a request for fire department assistance and combinations thereof.

22. The method according to claim 20, wherein the stored information comprises user identification information and location information.

23. The method according to claim 19, wherein processing the received message comprises,
(A) matching the received message with a user profile;
(B) storing the user profile and message in a secure but accessible form; and
(C) contacting one or more service centers according to the request in the message.

24. The method according to claim 23, wherein the service center is selected from the group consisting of a medical service center, a roadside assistance service center, a police service center, an insurance adjuster service center, a fire department service center and combinations thereof.
